(19) United States
(12) Patent Application Publication
(10) Pub. No.: US 2010/0156015 A1
(43) Pub. Date: Jun. 24, 2010

(54) Clamp and process for the production of a clamp

(75) Inventors: Thomas Klein, Ottmarsheim (DE); Hans Roesch, Gemmrigheim (DE); Gerhard Kloepfer, Pleidelsheim (DE)

Correspondence Address: Lipsitz & McAllister, LLC, 755 MAIN STREET, MONROE, CT, 06468, US

(73) Assignee: BESSEY Tool GmbH & Co. KG, Bietigheim-Bissingen (DE)

(21) Appl. No.: 12/592,941

(22) Filed: Dec. 4, 2009

Related U.S. Application Data
(63) Continuation of application No. PCT/EP2008/058262, filed on Jun. 27, 2008.

(30) Foreign Application Priority Data
Jul. 4, 2007 (DE) 10 2007 032 146

(51) Int. Cl. B25B 5/10; B25B 5/16; B21D 31/00

(52) U.S. Cl. 269/166; 269/249; 269/271; 72/362

(57) ABSTRACT

A clamp is proposed, comprising a slide rail, a slide arm movable on the slide rail, a fixed arm made of a metallic material, which is fixedly arranged on the slide rail, and a pressure piece for a workpiece, which is arranged on the fixed arm, wherein the slide rail and the fixed arm are connected in one piece, and wherein the pressure piece is a separate part from the fixed arm and is secured with a form-locking and/or force-locking fit on the fixed arm.

This application is a continuation of international application number PCT/EP2008/058262 filed on Jun. 27, 2008.

The present disclosure relates to the subject matter disclosed in international application number PCT/EP2008/058262 of Jun. 27, 2008 and German application number 10 2007 032 146.7 of Jul. 4, 2007, which are incorporated herein by reference in their entirety and for all purposes.

### BACKGROUND OF THE INVENTION

The invention relates to a clamp, comprising a slide rail made of metallic material, a slide arm movable on the slide rail, a fixed arm made of a metallic material, which is fixedly arranged on the slide rail, and a pressure piece for a workpiece, which is arranged on the fixed arm, the slide rail and the fixed arm being connected in one piece.

The invention additionally relates to a process for the production of a clamp.

BESSEY Tool GmbH & Co. KG distributes screw clamps under the designation LM. These have a slide rail and a fixed arm. The fixed arm is a separate structural part from the slide rail and is held pressed against the slide rail.

They additionally distribute all-steel screw clamps under the designation GZ with a slide arm/fixed arm/pressure piece combination in one piece that is produced by hot-forming.

A clamp is known from DE 100 05 350 A1 that has a rail for guiding a slide arm carrying a clamping mechanism and a fixed arm integrally formed in uniform material from the same profile, wherein the rail and fixed arm are connected to one another by means of a bent elbow part and substantially extend at right angles to one another.

A C-shaped clamp for clamping workpieces is known from DE 42 36 049 A1 that has a C-shaped clamp bar, a spindle nut arranged at one end of the clamp bar, a clamping spindle disposed in the spindle nut and a support arranged on the lower end of the clamp bar. The clamp bar has a guide section with guide faces for guiding continuously adjustable additional elements for the C-shaped clamp.

A screw clamp that clamps over a flat surface is known from EP 0 070 400 A2 that has a guide rail, on which a fixed clamp extending transversely thereto is arranged and also a slide clamp approximately parallel to said fixed clamp is displaceably guided. An internal thread for a screw spindle running approximately parallel to the guide rail is provided in a first of the two clamp parts. In addition, two clamping surface shoes are provided, one of which is arranged on the second of the two clamp parts and the other is arranged on a plate-shaped cap, which in particular is rotatably mounted on the screw spindle, has clamping faces facing one another and can tilt around axes perpendicular to the plane of the two clamp parts.

Further clamps are known from FR 1 070 193 and U.S. Pat. No. 2,815,778.

### SUMMARY OF THE INVENTION

In accordance with the present invention, a clamp is provided, which can be fabricated in a simple manner.

In accordance with an embodiment of the invention, the pressure piece is a separate part from the fixed arm and is secured with a form-locking and/or force-locking fit on the fixed arm.

The slide rail can be produced in its profiling together with the fixed arm from a continuous sheet material by means of cold-forming such as cold-drawing or cold-rolling. The cold-formed material has substantially increased strength values compared to a material in the natural state. If the slide rail and the fixed arm are connected in one piece, this corresponding combination can be produced in a simple manner by bending.

It is basically the case that if heating is conducted for material deformation on a workpiece produced by cold-forming, an undesirable structural change with a deterioration in the strength values occurs. In the solution in accordance with the invention, in order to prevent such a structural change the pressure piece that acts on a workpiece is subsequently arranged on the fixed arm, and therefore is not produced in one piece on the fixed arm. As a result, no heating of the fixed arm and the slide rail is necessary, so that similarly no structural change with loss of strength occurs.

During clamping of one or more workpieces, the pressure piece is substantially subjected only to a compression force. The fixed arm is subjected to the stronger force and in particular also tensile forces and bending forces. A high stability with optimised spreading of forces results from being secured to the slide rail in one piece.

In accordance with the invention, a clamp is provided that can be produced in a simple and inexpensive manner.

In one embodiment, the pressure piece is secured to the fixed arm by pressing. As a result, the pressure piece can be easily secured and firmly held in place.

It is also possible, for example, that the pressure piece is secured to the fixed arm by a locking or pin or screw connection, in particular with a positive fit.

It is most particularly advantageous if the pressure piece is secured to the fixed arm by a process which does not require the fixed arm to be heated in a structure-changing manner. This enables the clamp in accordance with the invention to be produced in a simple manner.

It is advantageous if the fixed arm is produced on the slide rail by bending. The fixed arm, oriented with a curvature transversely to the slide rail, can then be produced in a bending machine from a corresponding (and in particular already profiled) preform. It is then no longer necessary to subsequently secure a separately produced fixed arm to the slide rail.

In particular, the fixed arm has a convexly curved outside face and a concavely curved inside face. Such a fixed arm can be produced on a profiled rail in a simple manner; the slide rail, which is substantially straight, and the fixed arm, which is curved, can then be formed on the profiled rail.

In particular, the outside face and the inside face are parallel to one another. This enables easy production; such a slide rail-fixed arm combination can be produced from a straight rail, which is produced by cold-forming and has a corresponding profile.

It is additionally favourable if the convexly curved outside face of the fixed arm merges tangentially into the slide rail and the concavely curved inside face of the fixed arm merges tangentially into the slide rail. This results in a “smooth” transition without any corners and edges. This again allows an optimised flow of force.

In one embodiment, the fixed arm comprises at least one region, which is (circular) ring segment-shaped. This allows the fixed arm to be produced in a simple manner by bending on a bending machine.

In particular, the slide rail is straight. This allows the slide arm to be guided on the slide rail.

It is advantageous if the combination of slide rail and fixed arm is produced by means of cold-forming. For example, the corresponding profile rod, on which the fixed arm is then later produced by bending, for example, is produced by cold-rolling or cold-drawing a continuous band (such as a steel band, for example).

In particular, an upper envelope plane of the slide rail and an upper envelope plane of the fixed arm coincide. Moreover, in particular, a lower envelope plane of the slide rail and a lower envelope plane of the fixed arm coincide. The fixed arm can be produced on the slide rail by plane bending.

In particular, there sits on the slide clamp a clamping device, which is aligned with a counter-pressure piece on the pressure piece on the fixed arm. This allows one or more workpieces to be clamped between the pressure piece and the counter-pressure piece.

It is then additionally favourable if the pressure piece and the counter-pressure piece have substantially parallel abutment surfaces for a workpiece to allow defined clamping.

It is provided in one embodiment that the clamping device comprises (at least) one clamping screw, which is guided on a thread of the slide arm. The slide arm can be secured by tilting it on the slide rail when clamping one or more workpieces between the pressure piece and the counter-pressure piece. A corresponding clamping force can be exerted by the clamping screw. Other configurations of the clamping device such as an eccentric clamp or lever clamp are also possible.

In particular, a rotational axis of the clamping screw meets the pressure piece. This allows a force to be exerted as desired with a direction of force that is coaxial to the direction of rotation.

It is favourable if the pressure piece has an abutment region with an abutment surface for a workpiece and a securing region for securing to the fixed arm. The pressure piece is connected to the fixed arm by means of the securing region. The abutment region provides the abutment surface for the workpiece.

For example, the pressure piece is in the form of a cap with a receiving space for a fixed arm region. The pressure piece can be mounted onto the fixed arm by means of the receiving space and be pressed with this, for example, to hold the pressure piece with a form-locking and/or force-locking fit on the securing region. A correspondingly large “inner” abutment surface is provided for the press fit of the pressure piece on the securing region.

It is also possible that the pressure piece is held solely by means of the securing region or additionally by means of form-locking elements such as screws or the like. Other possibilities of form-locking such as locking or also pin connection are also possible.

In an exemplary embodiment, the pressure piece has an abutment region, which extends into the vicinity of the slide rail or as far as the slide rail or into a region of the fixed arm near to the slide rail. An enlarged abutment region is provided as a result of this. Since the pressure piece separated from the securing region, the abutment surface of the pressure piece does not have to follow the shape of the fixed arm. This can be used to increase the size of the abutment surface.

In an exemplary embodiment, the abutment region is secured to the slide rail or the region of the fixed arm near to the slide rail. The stability is increased as a result of this.

In particular, the fixing is form-locking and/or force-locking, and therefore no heating that changes structure (and therefore reduces strength) is necessary for the fixture.

In accordance with the present invention, a process for the production of a clamp is provided, which can be conducted in a simple manner.

In accordance with an embodiment of the invention, a preform for the slide rail and a fixed arm are produced by cold-forming, the fixed arm is produced on the preform by bending, and a pressure piece is secured to the fixed arm by form-locking and/or force-locking fit.

The process in accordance with the invention has the advantages already explained in association with the clamp in accordance with the invention.

Profile rails with the corresponding (end) profile of the slide rail can be produced from a continuous material by cold-forming (in particular cold-drawing or cold-rolling). The fixed arm is then produced on such a profile rail by bending in particular in a bending machine. The necessary abutment surface for a workpiece on the fixed arm is obtained by subsequently securing a pressure piece.

The following description of preferred embodiments serves to explain the invention in more detail.

### BRIEF DESCRIPTION OF THE DRAWINGS

FIG. 1 is a perspective representation of a first exemplary embodiment of a clamp in accordance with the invention;

FIG. 2 is a plan view onto the clamp according to FIG. 1;

FIG. 3 is a view of the clamp according to FIG. 2 in direction A;

FIG. 4 is a view of the clamp according to FIG. 2 in direction B;

FIG. 5 is a perspective representation of a second exemplary embodiment of a clamp in accordance with the invention;

FIG. 6 is a plan view onto the clamp according to FIG. 5; and

FIG. 7 is a view of the clamp according to FIG. 6 in direction B.

### DETAILED DESCRIPTION OF THE INVENTION

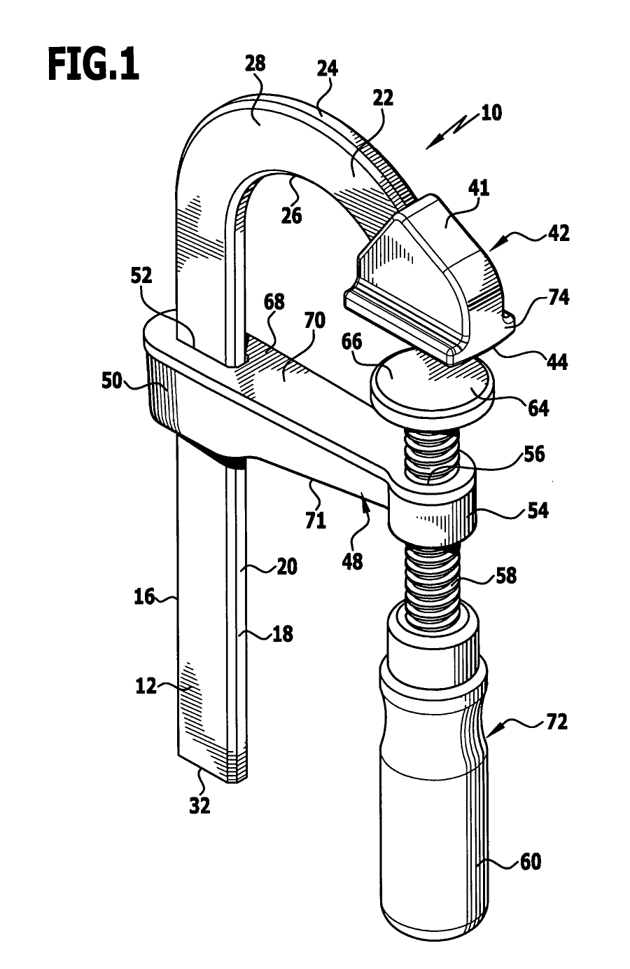

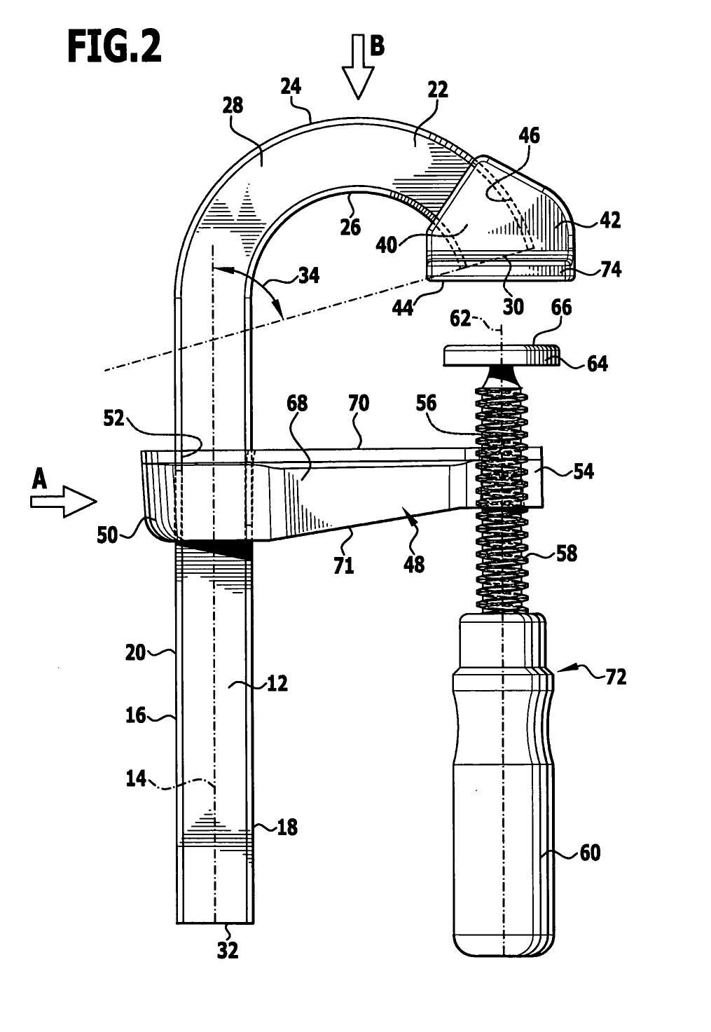

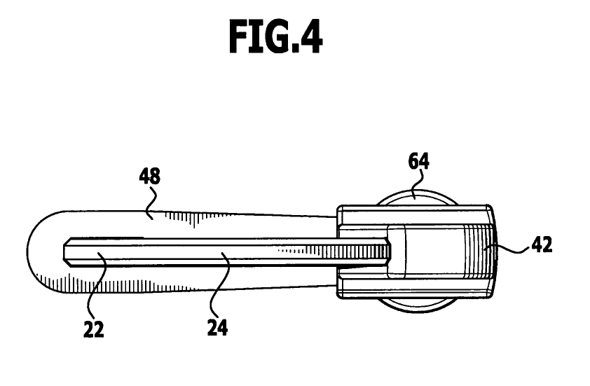

The exemplary embodiment of a clamp in accordance with the invention shown in FIGS. 1 to 4 and given the reference 10 there is a screw clamp. The screw clamp 10 comprises a slide rail 12. The slide rail 12 is made from a metallic material such as steel, for example. It extends straight in a longitudinal direction 14 (FIG. 2). An outside face 16 and an inside face 18 of the slide rail 12 are parallel to one another and parallel to the longitudinal direction 14.

The slide rail 12 is profiled. It has a respective fluting 20, for example, in the region of the outside face 16 and in the region of the inside face 18.

A fixed arm 22, which acts on a workpiece during clamping, is connected in one piece to the slide rail 12. The fixed arm 22 is a cantilever arm on the slide rail 12. This fixed arm 22 projects transversely beyond the outside face 16 and the inside face 18 of the slide rail 12. The fixed arm 22 itself has a convex outside face 24, which merges tangentially into the outside face 16 of the slide rail 12. In addition, the fixed arm 22 has a concave inside face 26, which merges tangentially into the inside face 18 of the slide rail 12.

The fixed arm 22 is produced by bending over on the slide rail 12. A profiled preform consisting of the slide rail and fixed arm, which is straight, is bent in a bending machine to produce the fixed arm 22 with the convex outside face 24 and the concave inside face 26.

The fixed arm 22 has a circular ring segment 28, for example. Other curved shapes are also possible.

In the shown exemplary embodiment, the fixed arm 22 has a face end 30. This has the same profile cross section as a face end 32 of the slide rail 12. The face end 30 of the fixed arm 22 is oriented at an angle to the longitudinal direction 14 of the slide rail 12, which lies in the order of magnitude of 70°, for example. This angle is indicated by the reference 34 in FIG. 2.

If the fixed arm 22 is ring segment-shaped, then the angle 34 substantially corresponds to the angular region, over which the fixed arm 22 extends when it is circular ring segment-shaped.

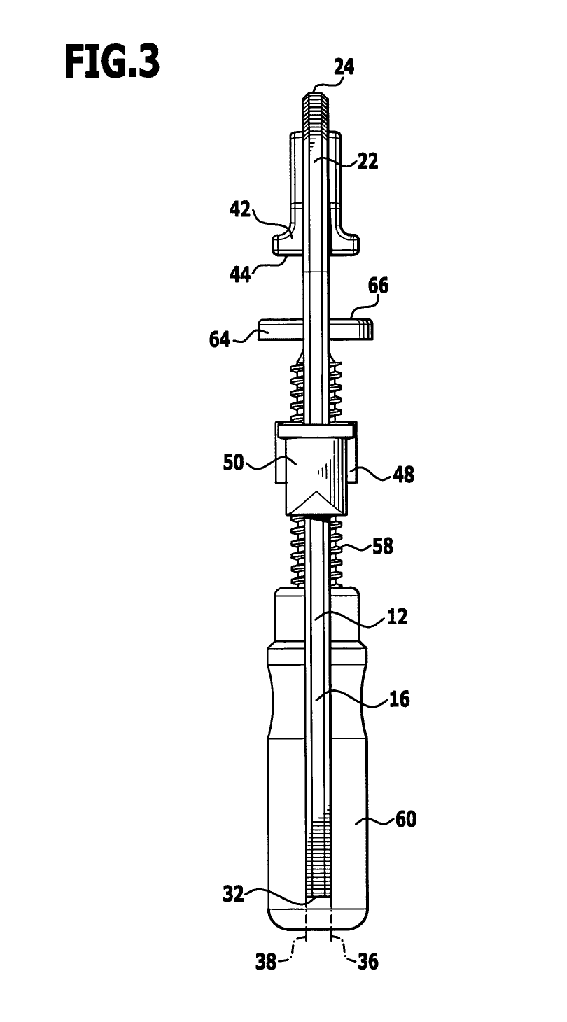

The slide rail 12 has an upper envelope plane 36 and a lower envelope plane 38 (FIG. 3). The two envelope planes 36 and 38 are substantially parallel to one another. The outside face 16 and the inside face 18 lie transversely and in particular perpendicular to the upper envelope plane 36 and the envelope plane 38. A corresponding upper envelope plane of the fixed arm 22 coincides with the upper envelope plane 36, and a corresponding lower envelope plane of the fixed arm 22 coincides with the lower envelope plane 38 of the slide rail 12.

The combination of profiled slide rail 12 and fixed arm 22 connected in one piece thereto is produced by cold-forming a metallic material and in particular by cold-drawing or cold-rolling.

For example, the combination of slide rail 12 and fixed arm 22 is produced with its profiling from a continuous band material by cold-drawing or cold-rolling before the fixed arm 22 is bent over. The material of this combination is strain-hardened. The fixed arm 22 is then produced with its convex outside face 24 and its concave inside face 26 on the slide rail 12 by bending before or after the fixed arm 22 is cut to size. The curvature is selected in such a manner that a “cold” bending is possible on a bending machine without the material being heated.

There sits on a securing region 40 (FIG. 2) of the fixed arm 22 a pressure element 42, which is held on the securing region 40 of the fixed arm 22 by means of a securing region 41 of the pressure piece 42. The securing region 40 is delimited by the end 30 of the fixed arm 22.

The pressure piece 42 has an abutment surface 44 for a workpiece. This abutment surface 44 is continuously connected. It can also be multipart. It is oriented transversely and in particular at least approximately perpendicular to the longitudinal direction 14 (and therefore to the slide rail 12).

The pressure piece 42 is a separate element from the fixed arm 22 and is subsequently secured thereto. The fixing occurs in such a manner that no heating of the fixed arm 22 is necessary. Such a heating can lead to a structural change of the structure of the fixed arm 22 (and the slide rail 12) produced by strain-hardening.

The pressure piece 42 can be produced from a metallic material or from a plastic material, for example.

The pressure piece 42 is secured to the fixed arm 22 with a force-locking and/or form-locking fit.

In an exemplary embodiment, the pressure piece 42 has a receiving space 46 on the securing region 41, with which it is mounted (and in particular pressed) onto the securing region 40 of the fixed arm 22 and undetachably pressed with this.

The pressure piece 42 is in particular in the form of a cap; it can be mounted onto the fixed arm 22 with the receiving space 46 during production of the screw clamp 10.

There are also further possibilities for securing the pressure piece 42 to the fixed arm 22. For example, this is secured with a form-locking fit on the fixed arm 22 by means of locking, pin or screw connection.

A slide arm 48 is arranged on the slide rail 12. This slide arm comprises a sliding region 50 with a recess 52. The slide rail 12 is passed through the recess 52.

The slide arm 48 additionally comprises a thread region 54. The thread region 54 has an internal thread 56, on which a clamping screw 58 is guided. The clamping screw 58 is held on a gripping element 60. The gripping element 60 is configured for holding by hand. The clamping screw 58 is caused to rotate around a rotational axis 62 by rotating the gripping element 60. In this case, depending on the direction of rotation, a counter-pressure piece 64 sitting on a front end of the clamping screw is moved towards the pressure piece 42 or away from this.

The counter-pressure piece 64 has an abutment surface 66 for a workpiece, which is oriented transversely and in particular substantially perpendicular to the slide rail 12 (in the longitudinal direction 14 thereof). In particular, the abutment surface 66 is aligned substantially parallel to the abutment surface 44 of the pressure piece 42.

The counter-pressure piece 64 can be mounted to pivot on the clamping screw 58 within a certain range. A type of spherical mounting can be provided for this, for example.

The slide arm 48 additionally has a bridge region 68 between the sliding region 50 and the thread region 54. The bridge region 68 together with the sliding region 50 and the thread region 54 has a, for example, plane side 70, which faces the fixed arm 22 and is oriented at least approximately perpendicularly to the slide rail 12. The bridge region 68 has a side 71 facing away from this that is oriented at an angle in the order of magnitude of approximately 170°, for example, to the slide rail 12 (and to the longitudinal direction 14 thereof).

The recess 52 of the slide arm 48 is dimensioned such that the slide arm 48 can tilt on the slide rail 12 with the fluting 20. As a result of this, one or more workpieces can then be clamped between the pressure piece 42 and the counter-pressure piece 64 by tightening the clamping screw 58.

The rotational axis 62 meets against the abutment surface 44 of the pressure element 42.

According to the invention, a clamp 10 is provided that can be produced in a simple manner. The fixed arm 22, which is curved, is arranged in one piece on the slide rail 12. The corresponding profiled preform can be produced in a simple manner by cold-forming and the fixed arm 22 is produced by bending. No subsequent joining of a fixed arm to the slide rail 12 is conducted. A joining region is fundamentally a critical region during loading. Such a critical region is avoided with the solution according to the invention.

The abutment surface 44 for one or more workpieces on the fixed arm 22 is provided by the pressure piece 42. This is a separate element from the fixed arm 22 and is subsequently secured to this. A sufficiently large and smooth abutment surface 44 can be provided as a result of this; no heating of the fixed arm 22 is necessary to produce the abutment surface 44. Such heating can lead to an undesirable structural change in the case of a cold-formed fixed arm 22.

The pressure piece 42 must absorb substantially only compression forces when a workpiece is clamped between a clamping device 72, which comprises the clamping screw 58 and the counter-pressure piece 64, and the pressure piece 42. The fixed arm 22 integrally formed on the slide rail 12 can absorb the corresponding tensile forces and bending forces.

A clamp such as a screw clamp, for example, is provided according to the invention that has the necessary mechanical stability while being simple to produce.

The pressure piece 42 has the securing region 41 and an abutment region 74, on which the abutment surface 44 is formed. The abutment region 74 can be configured so that in relation to a thickness direction of the slide rail 12 (between the upper envelope plane 36 and the lower envelope plane 38) it has a larger width than the securing region 41. This enables a sufficiently large abutment surface 44 and also a continuously connected abutment surface 44 to be provided.

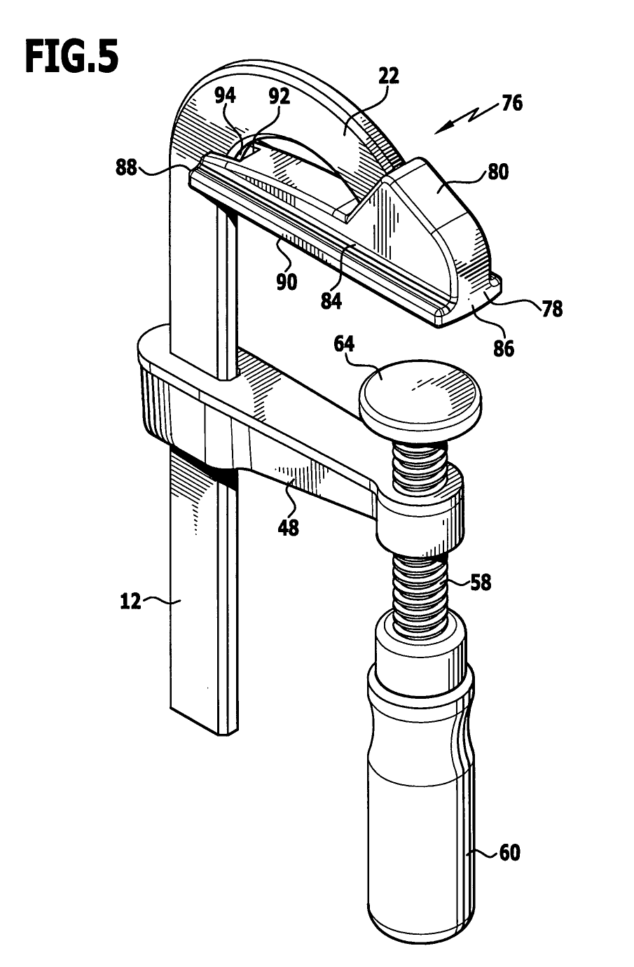

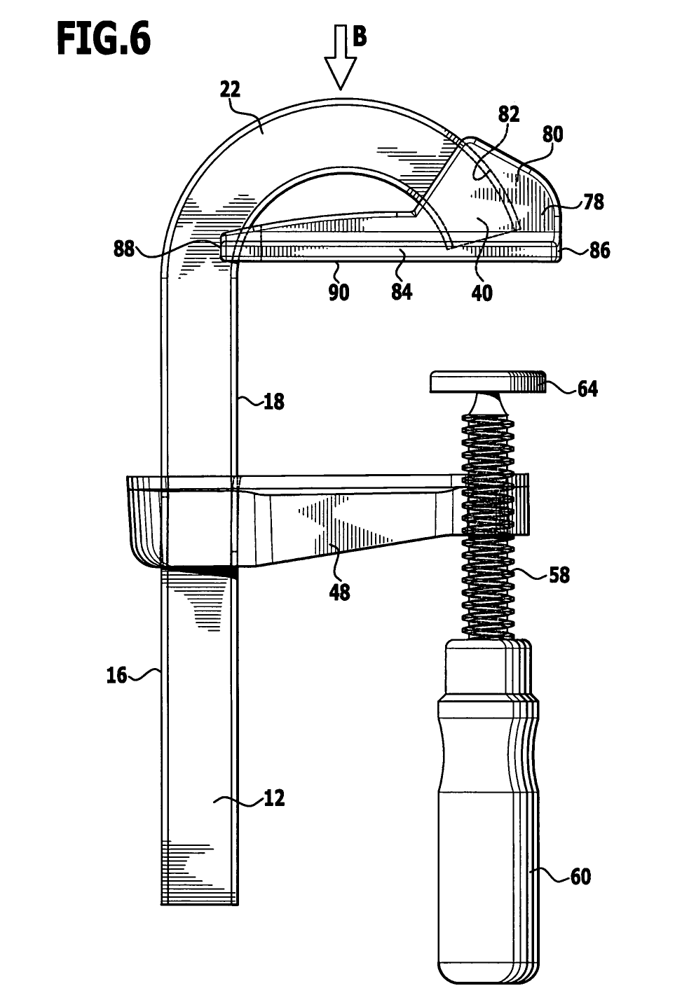

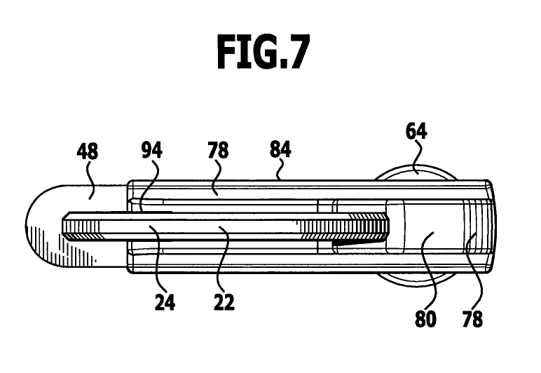

A second exemplary embodiment of a clamp, which is shown in FIGS. 5 to 7 and is given the reference 76 there, is also a screw clamp. Screw clamp 76 is configured in the same manner as screw clamp 10 except for a pressure piece 78. The same references are used for the same elements.

The pressure piece 78 has a securing region 80 with a receiving space 82. The pressure piece 78 is mounted onto the securing region 40 of the fixed arm 22 by means of the receiving space 82. In particular, the pressure piece 78 is pressed on.

The pressure piece 78 additionally has an abutment region 84, which sits on the securing region 80 and in particular sits thereon in one piece. The abutment region 84 extends from an upper end 86 of the pressure piece 78 having the largest spacing of the pressure piece 78 from the slide rail 12, as far as an end 88 lying above the slide rail 12. An abutment region 90, which is simply or multiply connected, is formed on the abutment region 84. This abutment surface 90 is oriented transversely and in particular perpendicularly to the slide rail 12. It extends from the upper end 86 as far as the slide rail 12 and then also beyond the inside face 18 of the slide rail 12. At or near to the end 88 the pressure piece 78 can be connected to the slide rail 12 with a force-locking and/or form-locking fit.

The pressure piece 78 provides an abutment surface 90 that extends as far as the slide rail 12.

A recess 92 can be arranged on the abutment region 84 in the region of the slide rail 12, in which recess a corresponding region 94 of the slide rail 12 at least partially lies.

Otherwise, screw clamp 76 operates as described above.

1. Clamp, comprising:
a slide rail;
a slide arm movable on the slide rail;
a fixed arm made of a metallic material, which is fixedly arranged on the slide rail; and
a pressure piece for a workpiece, which is arranged on the fixed arm;
wherein the slide rail and the fixed arm are connected in one piece; and
wherein the pressure piece is a separate part from the fixed arm and is secured with at least one of a form-locking and a force-locking fit on the fixed arm.

2. Clamp according to claim 1, wherein the pressure piece is secured to the fixed arm by pressing.

3. Clamp according to claim 1, wherein the pressure piece is secured to the fixed arm by a locking connection or pin connection or screw connection.

4. Clamp according to claim 1, wherein the pressure piece is secured to the fixed arm by a process which does not require the fixed arm to be heated in a structure-changing manner.

5. Clamp according to claim 1, wherein the fixed arm is produced on the slide rail by bending.

6. Clamp according to claim 1, wherein the fixed clamp has a convexly curved outside face and a concavely curved inside face.

7. Clamp according to claim 6, wherein the outside face and the inside face are parallel to one another.

8. Clamp according to claim 6, wherein the convexly curved outside face of the fixed clamp merges tangentially into the slide rail.

9. Clamp according to claim 6, wherein the concavely curved inside face of the fixed clamp merges tangentially into the slide rail.

10. Clamp according to claim 6, wherein the fixed arm comprises at least one region, which is ring segment-shaped.

11. Clamp according to claim 1, wherein the slide rail is straight.

12. Clamp according to claim 1, wherein the combination of slide rail and fixed arm is produced by means of cold-forming.

13. Clamp according to claim 1, wherein an upper envelope plane of the slide rail and an upper envelope plane of the fixed arm coincide.

14. Clamp according to claim 1, wherein a lower envelope plane of the fixed arm and a lower envelope plane of the slide rail coincide.

15. Clamp according to claim 1, wherein there sits on the slide arm a clamping device, which is aligned with a counter-pressure piece on the pressure piece on the fixed arm.

16. Clamp according to claim 15, wherein the pressure piece and the counter-pressure piece have substantially parallel abutment surfaces for a workpiece.

17. Clamp according to claim 15, wherein the clamping device comprises a clamping screw, which is guided on a thread of the slide arm.

18. Clamp according to claim 17, wherein a rotational axis of the clamping screw meets the pressure piece.

19. Clamp according to claim 1, wherein the pressure piece has an abutment region and a securing region for securing to the fixed arm.

20. Clamp according to claim 1, wherein the pressure piece is in the form of a cap with a receiving space for a fixed arm region.

21. Clamp according to claim 1, wherein the pressure piece has an abutment region, which extends near to the slide rail or as far as the slide rail or into a region of the fixed arm near to the slide rail.

22. Clamp according to claim 21, wherein the abutment region is secured to the slide rail or the region of the fixed arm near to the slide rail.

23. Clamp according to claim 22, wherein the securement is at least one of form-locking and force-locking.

24. Process for the production of a clamp according to claim 1, comprising:
producing a preform for the slide rail and the fixed arm by cold-forming;
producing the fixed arm on the preform by bending; and
securing a pressure piece to the fixed arm by form-locking or force-locking fit.
